(19) United States
(12) Patent Application Publication
(10) Pub. No.: US 2026/0097635 A1
(43) Pub. Date: Apr. 9, 2026

(54) VEHICLE

(71) Applicant: KAWASAKI MOTORS, LTD., Hyogo (JP)

(72) Inventors: Kenta NAKAMURA, Lincoln, NE (US); Hirokazu MORITA, Akashi-shi (JP); Kazumasa HISADA, Akashi-shi (JP)

(73) Assignee: KAWASAKI MOTORS, LTD., Hyogo (JP)

(21) Appl. No.: 18/907,668

(22) Filed: Oct. 7, 2024

(51) Int. Cl. B60K 1/04; B60L 50/60; B60N 2/015; B60N 2/68; B62D 25/20; H01M 50/249; H01M 50/271

(52) U.S. Cl. CPC B60K 1/04; B60L 50/66; B60N 2/015; B60N 2/686; B62D 25/20; H01M 50/249; H01M 50/271; B60K 2001/0433; H01M 2220/20

(57) ABSTRACT

A vehicle includes: a frame body including a floor frame and a seat support frame located at an upper side of the floor frame; and a battery supported by the frame body, at least part of the battery being located in an under-seat space surrounded by the seat support frame and the floor frame. The frame body defines an entrance opening which is located at a lateral side of the seat and through which an occupant passes when the occupant gets in and out of the vehicle. The seat support frame defines a battery passing opening which opens the under-seat space in a horizontal direction and has such a size that the battery can pass through the battery passing opening.

### BACKGROUND OF THE INVENTION

### Field of the Invention

The present disclosure relates to a vehicle including a battery.

### Description of the Related Art

US 2010/0317485 A1 discloses an electric vehicle on which a battery is mounted. To increase a cruising distance of the electric vehicle, it is desired to mount a large battery on the electric vehicle. When the battery is increased in size, the ease of work of mounting the battery deteriorates.

One aspect of the present disclosure is to provide a vehicle on which a battery is easily mounted.

### SUMMARY OF THE INVENTION

A vehicle according to one aspect of the present disclosure includes: a left wheel and a right wheel which are located with an interval in a vehicle left-right direction; a frame body including a floor frame and a seat support frame located at an upper side of the floor frame; a seat supported by the seat support frame from below; and a battery supported by the frame body, at least part of the battery being located in an under-seat space surrounded by the seat support frame and the floor frame. The frame body defines an entrance opening which is located at a lateral side of the seat and through which an occupant passes when the occupant gets in and out of the vehicle. The seat support frame defines a battery passing opening which opens the under-seat space in a horizontal direction and has such a size that the battery passes through the battery passing opening.

### BRIEF DESCRIPTION OF THE DRAWINGS

FIG. 1 is a left side view of an off-road vehicle according to an embodiment.

FIG. 2 is a left side view showing a frame body and a battery assembly in the off-road vehicle of FIG. 1.

FIG. 3 is a plan view showing the frame body and the battery assemblies shown in FIG. 2.

FIG. 4 is a perspective view showing the frame body and the battery assemblies shown in FIG. 3 when viewed from a rear left side.

FIG. 5 is a horizontal sectional view showing the frame body and the battery assemblies shown in FIG. 3.

FIG. 6 is a perspective view showing a rear fender of the off-road vehicle of FIG. 1 and its vicinity when viewed from the rear left side.

FIG. 7 is a perspective view showing an entrance opening for a rear seat of the off-road vehicle of FIG. 1 when viewed from a front left side.

FIG. 8 is a horizontal sectional view showing a partition wall of FIG. 7 and its vicinity.

FIG. 9 is a perspective view showing the frame body and the battery assembly shown in FIG. 2 when viewed from the front left side through a rear entrance opening.

FIG. 10 is a left side view showing the battery assembly of Modified Example and its vicinity.

FIG. 11 is a diagram showing a battery layout of Modified Example and corresponding to FIG. 5.

### DETAILED DESCRIPTION

Hereinafter, an embodiment will be described with reference to the drawings. Directions stated in the following description are based on directions from the viewpoint of a driver who is in an off-road vehicle 1. To be specific, a direction in which the off-road vehicle 1 travels straight is referred to as a front-rear direction, and a lateral direction orthogonal to the front-rear direction is referred to as a left-right direction.

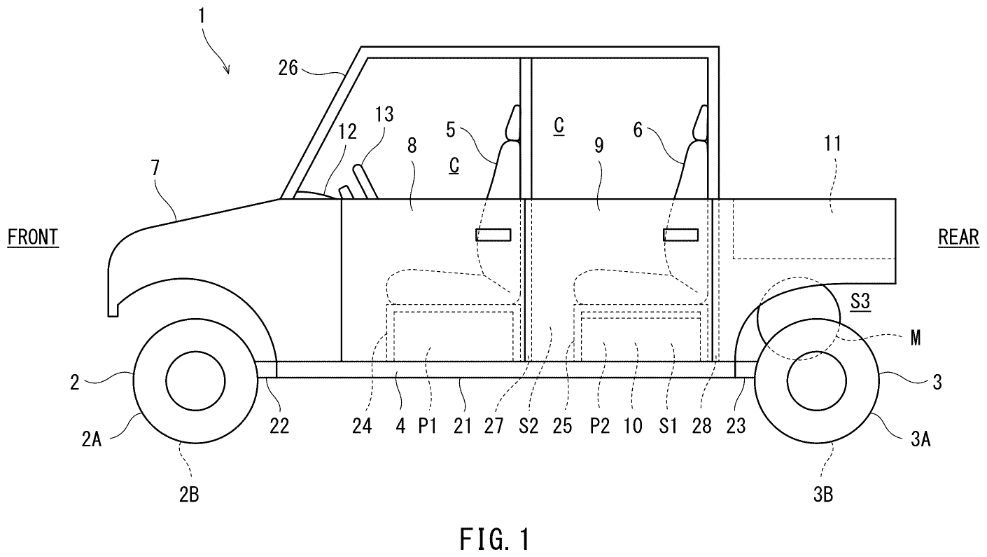

FIG. 1 is a left side view of the off-road vehicle 1 according to the embodiment. As shown in FIG. 1, the off-road vehicle 1 includes: front wheels 2 including a left wheel 2A and a right wheel 2B which are located with an interval in a vehicle left-right direction; and rear wheels 3 including a left wheel 3A and a right wheel 3B which are located with an interval in the vehicle left-right direction. The front wheels 2 and the rear wheels 3 support a frame body 4. Balloon tires are used for the front wheels 2 and the rear wheels 3. The frame body 4 is a pipe frame including pipes connected to each other.

The frame body 4 includes a floor frame 21, a front frame 22, a rear frame 23, a front seat support frame 24, a rear seat support frame 25, and a cabin frame 26. The front seat support frame 24 and the rear seat support frame 25 located rearwardly away from the front seat support frame 24 are located at an upper side of the floor frame 21. The front seat support frame 24 supports a front seat 5 from below. The rear seat support frame 25 supports a rear seat 6 from below. An under-seat space SI surrounded by the floor frame 21 and the rear seat support frame 25 is defined vertically under the rear seat 6.

The cabin frame 26 is located above the floor frame 21. The cabin frame 26 surrounds an occupant space C where the front seat 5 and the rear seat 6 are located. A dashboard 12 is located in front of the front seat 5. A steering wheel 13 operated by the driver seated on the front seat 5 is located at the dashboard 12.

The frame body 4 defines a front entrance opening Pl located at a lateral side of the front seat 5. The front entrance opening P1 is a side opening through which an occupant gets onto the front seat 5 from an outside of the off-road vehicle 1. The frame body 4 defines a rear entrance opening P2 located at the lateral side of the rear seat 6. The rear entrance opening P2 is a side opening through which the occupant gets onto the rear seat 6 from the outside of the off-road vehicle 1.

The cabin frame 26 includes a front post 27 and a rear post 28 which are located at a vehicle left-right direction outside portion of the floor frame 21 and extend upward from the floor frame 21. The front post 27 and the rear post 28 are welded to the floor frame 21. A rear foot space S2 where the feet of the occupant seated on the rear seat 6 are placed is located between the front seat support frame 24 and the rear seat support frame 25. In a vehicle side view, the front post 27 is located at a front side of the rear foot space S2 and between the front entrance opening P1 and the rear entrance opening P2. In the vehicle side view, the rear post 28 is located at a rear side of the under-seat space S1.

A front side door 8 that openably closes the front entrance opening Pl is located at the lateral side of the front seat 5. A rear side door 9 that openably closes the rear entrance opening P2 is located at the lateral side of the rear seat 6.

The front frame 22 extends forward from the floor frame 21. The front frame 22 is located between the left wheel 2A and the right wheel 2B that are the front wheels 2. The front frame 22 are supported by the front wheels 2 through suspensions. The front frame 22 supports a hood 7 located in front of the cabin frame 26. The hood 7 openably covers a front space between the left wheel 2A and the right wheel 2B from above.

The rear frame 23 extends rearward from the floor frame 21. The rear frame 23 is located between the left wheel 3A and the right wheel 3B that are the rear wheels 3. The rear frame 23 is supported by the rear wheels 3 through suspensions. The rear frame 23 supports a cargo bed 11 located behind the rear seat 6. The cargo bed 11 is open upward. An electric motor structure M supported by the rear frame 23 is located in an under-cargo-bed space S3 located under the cargo bed 11.

The electric motor structure M includes at least an electric motor. The electric motor structure M may include a reduction gear together with the electric motor in a casing thereof. The electric motor structure M is connected to a power transmitting structure that transmits driving power to the front wheels 2 or the rear wheels 3 or to both of the front wheels 2 and the rear wheels 3. In a 2WD mode, the driving power output by the electric motor structure M is transmitted to the front wheels 2 or the rear wheels 3. In a 4WD mode, the driving power output by the electric motor structure M is transmitted to the front wheels 2 and the rear wheels 3. To be specific, the off-road vehicle 1 is a motor-driven off-road vehicle. Battery assemblies 10 as power supplies for the electric motor structure M are mounted on the frame body 4. The battery assemblies 10 that are relatively large are used to increase a cruising distance of the off-road vehicle 1 in wasteland where there is no charging facility.

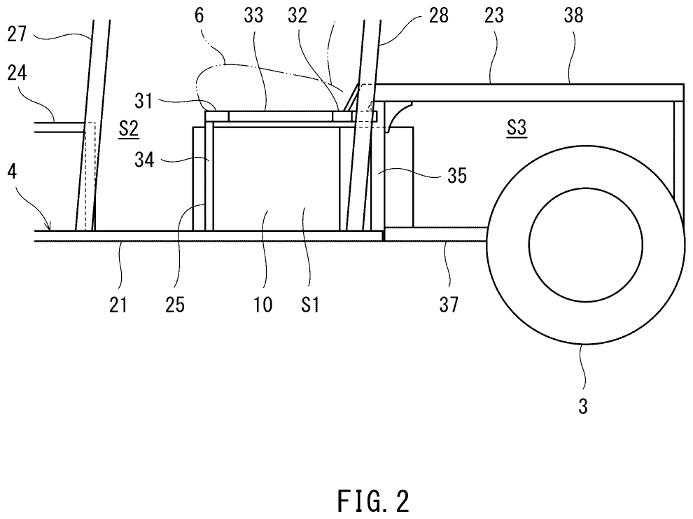

FIG. 2 is a left side view showing the frame body 4 and the battery assembly 10 in the off-road vehicle 1 of FIG. 1. As shown in FIG. 2, at least part of the battery assembly 10 is located in the under-seat space S1 surrounded by the floor frame 21 and the rear seat support frame 25. The rear seat support frame 25 includes a front cross frame 31, a rear cross frame 32, horizontal frames 33, and vertical frames 34.

The front cross frame 31 extends in the vehicle left-right direction at a position upwardly away from the floor frame 21 and supports a front portion of the rear seat 6 from below. The rear cross frame 32 extends in the vehicle left-right direction at a position rearwardly away from the front cross frame 31 and upwardly away from the floor frame 21 and supports a rear portion of the rear seat 6 from below. The horizontal frames 33 extend in the vehicle front-rear direction and couple the front cross frame 31 to the rear cross frame 32. The vertical frames 34 extend upward from the floor frame 21 to the front cross frame 31 and couple the front cross frame 31 to the floor frame 21.

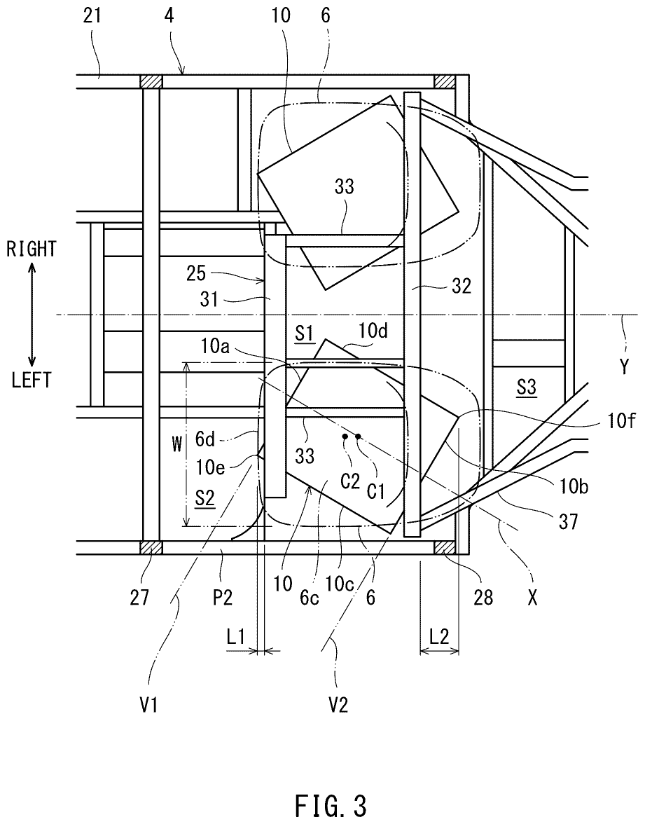

FIG. 3 is a plan view showing the frame body 4 and the battery assemblies 10 shown in FIG. 2. As shown in FIG. 3, in a vehicle plan view, two battery assemblies 10 are located bilaterally symmetrically with respect to a vehicle center line Y so as to sandwich the vehicle center line Y. The vehicle center line Y passes through a center of the off-road vehicle 1 and extends in the vehicle front-rear direction. Hereinafter, the battery assembly 10 at a left side out of the two battery assemblies 10 will be mainly described.

The battery assembly 10 has a substantially hexahedron shape. In the vehicle plan view, the battery assembly 10 has a substantially square shape. Specifically, the battery assembly 10 has a substantially cuboid shape. In the vehicle plan view, the battery assembly 10 has a substantially rectangular shape. In the vehicle plan view, four sides of a contour of the battery assembly 10 are inclined with respect to the vehicle center line Y. In the present embodiment, in the vehicle plan view, a longitudinal axis X of the battery assembly 10 is inclined with respect to the vehicle center line Y. The longitudinal axis X of the battery assembly 10 is a virtual line that passes through a center of the battery assembly 10 and extends in a longitudinal direction of the battery assembly 10.

The battery assembly 10 includes a front surface 10a, a rear surface 10b, an outer side surface 10c, and an inner side surface 10d. The front surface 10a, the rear surface 10b, the outer side surface 10c, and the inner side surface 10d are surfaces directed to a horizontal direction. The front surface 10a extends obliquely with respect to the vehicle left-right direction so as to be directed to a vehicle front side and an inside in the vehicle left-right direction. The rear surface 10b extends obliquely with respect to the vehicle left-right direction so as to be directed to a vehicle rear side and an outside in the vehicle left-right direction. The outer side surface 10c is inclined with respect to the vehicle center line Y in the vehicle plan view so as to be directed to the vehicle front side and the outside in the vehicle left-right direction. The inner side surface 10d is inclined with respect to the vehicle center line Y in the vehicle plan view so as to be directed to the vehicle rear side and the inside in the vehicle left-right direction.

The battery assembly 10 includes: a front corner portion 10e that connects the front surface 10a and the outer side surface 10c with each other and is directed to the vehicle front side; and a rear corner portion 10f that connects the rear surface 10b and the inner side surface 10d with each other and is directed to the vehicle rear side. The front corner portion 10e of the battery assembly 10 is located at the vehicle front side of the rear seat support frame 25. The rear corner portion 10f of the battery assembly 10 is located at the vehicle rear side of the rear seat support frame 25. The rear corner portion 10f of the battery assembly 10 is directed to the under-cargo-bed space S3 located vertically under the cargo bed 11.

In the vehicle plan view, a center Cl of the battery assembly 10 is located at the vehicle rear side of an intermediate point C2 between the front cross frame 31 and the rear cross frame 32 in the vehicle front-rear direction. The battery assembly 10 is eccentrically located at the vehicle rear side of the rear seat support frame 25. A projecting amount L1 of the front corner portion 10e of the battery assembly 10 from the rear seat support frame 25 toward the vehicle front side is smaller than a projecting amount L2 of the rear corner portion 10f of the battery assembly 10 from the rear seat support frame 25 toward the vehicle rear side. In the vehicle plan view, a distance L1 from the front cross frame 31 to the front corner portion 10e of the battery assembly 10 in the vehicle front-rear direction is shorter than a distance L2 from the rear cross frame 32 to the rear corner portion 10f of the battery assembly 10 in the vehicle front-direction.

In the vehicle plan view, the area of a portion of the battery assembly 10 which projects from the front cross frame 31 toward the vehicle front side is smaller than the area of a portion of the battery assembly 10 which projects from the rear cross frame 32 toward the vehicle rear side. In other words, the volume of a portion of the battery assembly 10 which projects from the rear seat support frame 25 toward the vehicle front side is smaller than the volume of a portion of the battery assembly 10 which projects from the rear seat support frame 25 toward the vehicle rear side.

The outer side surface 10c of the battery assembly 10 is directed to the rear entrance opening P2 located between the front post 27 and the rear post 28. A virtual extension surface V1 of the front surface 10a of the battery assembly 10 passes through the rear entrance opening P2, and a virtual extension surface V2 of the rear surface 10b of the battery assembly 10 also passes through the rear entrance opening P2.

An upper portion of the rear seat support frame 25 covers the battery assembly 10 from above. In the vehicle plan view, the front cross frame 31, the rear cross frame 32, and the horizontal frame 33 overlap the battery assembly 10 from above. In the vehicle plan view, a gap between the front cross frame 31 and the rear cross frame 32 has such a shape and size that the battery assembly 10 cannot pass therethrough. The front cross frame 31, the rear cross frame 32, and the horizontal frame 33 prevent an upward movement of the battery assembly 10. In the vehicle plan view, the rear seat 6 overlaps the battery assembly 10 from above.

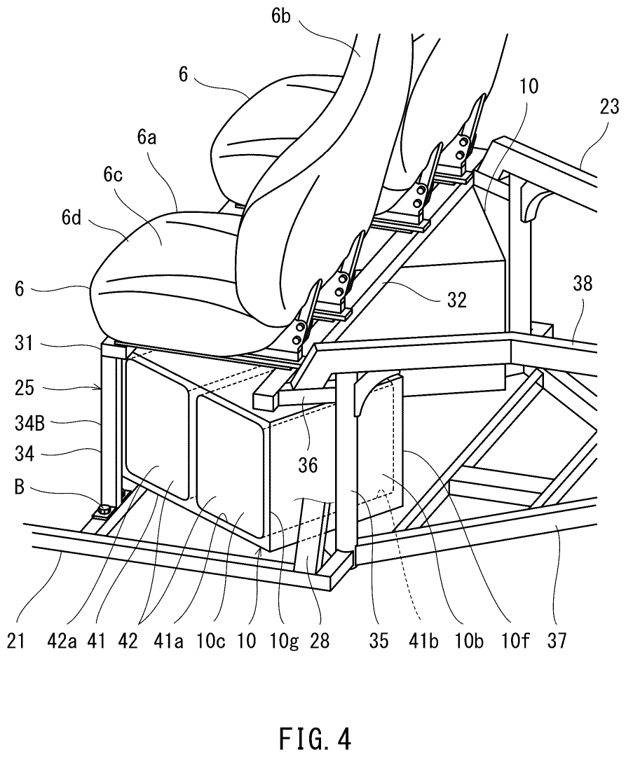

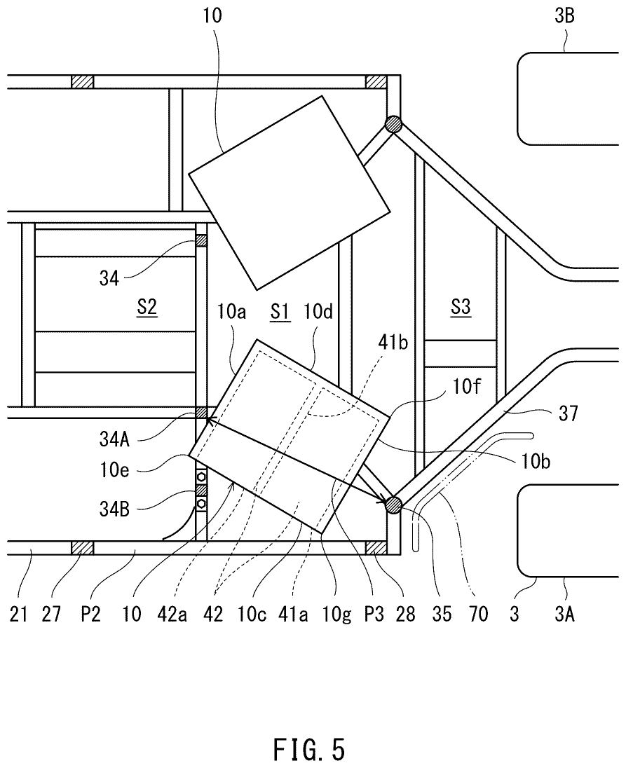

FIG. 4 is a perspective view showing the frame body 4 and the battery assemblies 10 shown in FIG. 3 when viewed from a rear left side. FIG. 5 is a horizontal sectional view showing the frame body 4 and the battery assemblies 10 shown in FIG. 3. As shown in FIGS. 4 and 5, the battery assembly 10 includes a battery case 41 and batteries 42 accommodated in the battery case 41. Each battery 42 includes an external terminal. The battery case 41 may accommodate only one battery 42. The battery case 41 includes an opening 41a on the outer side surface 10c of the battery assembly 10.

The battery case 41 includes a guide 41b extending toward the opening 41a in an accommodating space thereof. The guide 41b is, for example, an inner surface of the battery case 41 but may be a guide rail. The battery 42 may be inserted into the battery case 41 through the opening 41a and may be taken out from the battery case 41 through the opening 41a. The battery 42 includes a front surface 42a that constitutes the outer side surface 10c of the battery assembly 10 when the battery 42 is accommodated in the battery case 41. The front surface 42a of the battery 42 is located so as to be directed to the rear entrance opening P2.

The front cross frame 31 is supported by the vertical frames 34, extending upward from the floor frame 21, from below. The vertical frames 34 are lined up at intervals in the vehicle left-right direction. The front corner portion 10e of the battery assembly 10 is located at the vehicle front side of the vertical frames 34.

The vertical frames 34 include an inner vertical frame 34A and an outer vertical frame 34B located outside the inner vertical frame 34A in the vehicle left-right direction. The inner vertical frame 34A and the outer vertical frame 34B are opposed to the battery assembly 10 from the vehicle front side. The front corner portion 10e of the battery assembly 10 projects toward the vehicle front side from a space between the inner vertical frame 34A and the outer vertical frame 34B. The inner vertical frame 34A is opposed to the front surface 10a of the battery assembly 10, and the outer vertical frame 34B is opposed to the outer side surface 10c of the battery assembly 10.

The inner vertical frame 34A is fixed to the floor frame 21 and the front cross frame 31 by welding. To be specific, the front cross frame 31 is not detachable from the floor frame 21. The outer vertical frame 34B is detachably fixed to the floor frame 21 and the front cross frame 31 by fasteners B, such as bolts. The outer vertical frame 34B is a detachable frame attachable to and detachable from a predetermined portion of the frame body 4 and is a reinforcing frame reinforcing the front cross frame 31.

The rear cross frame 32 is supported by a vertical frame 35 projecting upward from the floor frame 21. The vertical frame 35 is located behind the rear cross frame 32 and projects upward from the floor frame 21. An upper portion of the vertical frame 35 is coupled to the rear cross frame 32 by a coupling frame 36. The coupling frame 36 is fixed to the vertical frame 35 and the rear cross frame 32 by welding. The vertical frame 35 is fixed to the floor frame 21 by welding. To be specific, the rear cross frame 32 is not detachable from the floor frame 21.

The rear frame 23 includes: a lower rear frame 37 extending rearward from a rear portion of the vehicle left-right direction outside portion of the floor frame 21; and an upper rear frame 38 located upwardly away from the lower rear frame 37. A front portion of the upper rear frame 38 is fixed to the vertical frame 35 and the coupling frame 36 by welding. The lower rear frame 37 and the upper rear frame 38 extend obliquely from the floor frame 21 toward the vehicle rear side and the inside in the vehicle left-right direction.

The rear corner portion 10f of the battery assembly 10 is located at the vehicle rear side of the vertical frame 35. In the vehicle plan view, the rear surface 10b of the battery assembly 10 is located at the inside of the lower rear frame 37 in the vehicle left-right direction and extends along the lower rear frame 37. The vertical frame 35 is directly or indirectly opposed to the rear surface 10b of the battery assembly 10 from behind. The battery assembly 10 includes an outer corner portion 10g that connects the rear surface 10b and the outer side surface 10c with each other and is directed to the outside in the vehicle left-right direction. The outer corner portion 10g of the battery assembly 10 is located outside the vertical frame 35 in the vehicle left-right direction.

The rear seat support frame 25 defines a battery passing opening P3 between the inner vertical frame 34A and the vertical frame 35. When viewed in a direction facing the outer side surface 10c of the battery assembly 10, the outer vertical frame 34B is located so as to close part of the battery passing opening P3. However, when the outer vertical frame 34B is detached by removing the fasteners B, the battery passing opening P3 is completely open when viewed in the direction facing the outer side surface 10c of the battery assembly 10.

The guide 41b of the battery case 41 guides the battery 42 between the battery passing opening P3 and a predetermined position in the under-seat space S1. Specifically, when taking out the battery 42 accommodated in the battery case 41, the guide 41b of the battery case 41 guides the battery 42 through the battery passing opening P3 to an outside of the vehicle. When attaching the battery 42, the guide 41b of the battery case 41 guides the battery 42, having passed through the battery passing opening P3 from the outside of the vehicle, through the opening 41a of the battery case 41 toward the accommodating space.

The rear seat 6 includes a seat portion 6a and a backrest portion 6b. An upper surface of the seat portion 6a is a seating region 6c that supports the buttocks of the occupant from below. The backrest portion 6b projects upward from a rear portion of the seat portion 6a and supports the back of the occupant from behind. Referring back to FIG. 3, in a width section W of the seat portion 6a of the rear seat 6 in the vehicle left-right direction, a right end of the seat portion 6a is regarded as 0%, and a left end of the seat portion 6a is regarded as 100%. In this case, the front corner portion 10e of the battery assembly 10 is located in a range of 40% to 60% of the seat portion 6a in the vehicle left-right direction. For example, regarding positions in the vehicle left-right direction, the position of the front corner portion 10e of the battery assembly 10 is substantially the same as the position of a middle portion 6d of the seating region 6c of the rear seat 6.

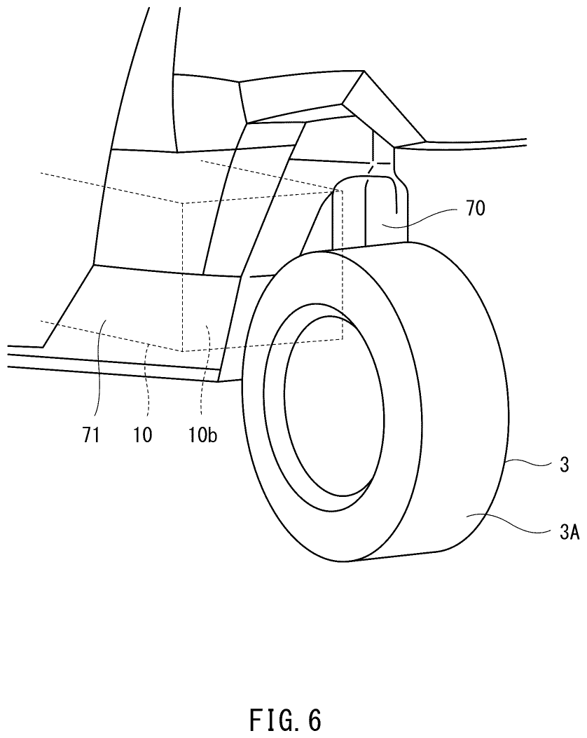

FIG. 6 is a perspective view showing a rear fender 70 of the off-road vehicle 1 of FIG. 1 and its vicinity when viewed from the rear left side. As shown in FIG. 6, the off-road vehicle 1 includes the rear fender 70 that covers the rear wheel 3 from the vehicle front side and the inside in the vehicle left-right direction. The rear fender 70 is attached to, for example, a side cowl 71 supported by the frame body 4. The battery assembly 10 is opposed to the rear fender 70 from the vehicle front side and the inside in the vehicle left-right direction. Specifically, the rear surface 10b of the battery assembly 10 is opposed to the rear fender 70 from the vehicle front side and the inside in the vehicle left-right direction.

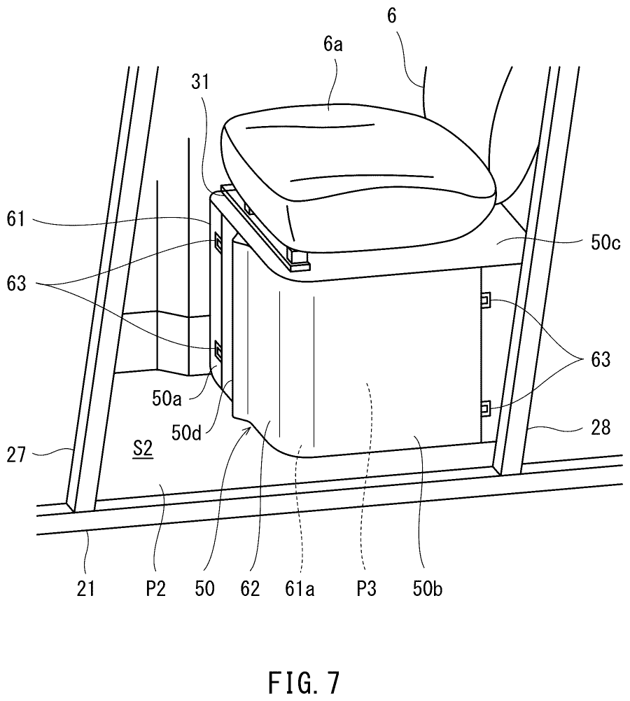

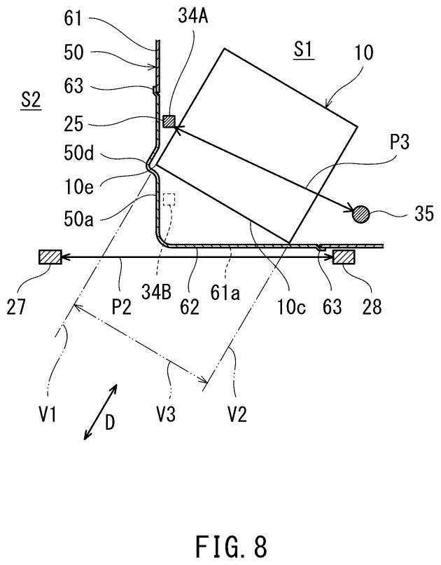

FIG. 7 is a perspective view showing the entrance opening P2 for the rear seat 6 in the off-road vehicle 1 of FIG. 1 when viewed from a front left side. FIG. 8 is a horizontal sectional view showing a partition wall 50 of FIG. 7 and its vicinity. As shown in FIGS. 7 and 8, the rear seat support frame 25 is covered with the partition wall 50 from the vehicle front side and the vehicle lateral side. The partition wall 50 covers the under-seat space S1 from the vehicle front side and the vehicle lateral side. The partition wall 50 is made of resin. The partition wall 50 includes a front wall portion 50a, a side wall portion 50b, and an upper wall portion 50c. The front wall portion 50a covers the rear seat support frame 25 from the vehicle front side and separates the rear foot space S2 and the under-seat space SI from each other. The side wall portion 50b covers the rear seat support frame 25 from the outside in the vehicle left-right direction. The upper wall portion 50c covers the rear seat support frame 25 from above while exposing the front cross frame 31 and the rear cross frame 32 to the upper side.

The partition wall 50 includes a partition wall main body 61 and a lid 62. The partition wall main body 61 includes a partition opening 61a. The lid 62 is detachably attached to the partition wall main body 61 so as to openably close the partition opening 61a. For example, the lid 62 is locked to the partition wall main body 61 by a locking structure 63. When the lid 62 is detached from the partition wall main body 61 by unlocking the locking structure 63, the partition opening 61a appears when viewed from the rear entrance opening P2 between the front post 27 and the rear post 28. The partition opening 61a makes the battery passing opening P3 of the rear seat support frame 25 communicate with the rear entrance opening P2.

The partition opening 61a has such a size that at least the battery 42 can pass therethrough. In the present embodiment, the partition opening 61a of the partition wall main body 61 has such a size that the battery assembly 10 can pass therethrough. For example, when viewed in a direction D facing the outer side surface 10c of the battery assembly 10, i.e., the direction D perpendicular to the outer side surface 10c, the battery 42 or the battery assembly 10 is located within the partition opening 61a of the partition wall main body 61.

The front wall portion 50a of the partition wall 50 includes a projecting portion 50d projecting toward the rear foot space S2 located in front of the partition wall 50. The projecting portion 50d has a shape extending along the front corner portion 10e of the battery assembly 10. The projecting portion 50d extends in a vertical direction along the front corner portion 10e of the battery assembly 10. In the vehicle plan view, the projecting portion 50d has a tapered shape extending along the front corner portion 10e of the battery assembly 10. An inner surface of the projecting portion 50d which is directed to the under-seat space SI has a groove shape that is recessed from the under-seat space S1 toward the rear foot space S2.

The projecting portion 50d of the partition wall 50 covers the front corner portion 10e of the battery assembly 10 from the vehicle front side. The front corner portion 10e of the battery assembly 10 is located at the groove of the inner surface of the projecting portion 50d. A portion of the partition wall 50 which is adjacent to the projecting portion 50d is located behind a front end of the projecting portion 50d. A tip of the front corner portion 10e of the battery assembly 10 is located at the vehicle rear side of an inner surface of a portion of the front wall portion 50a which is adjacent to the projecting portion 50d.

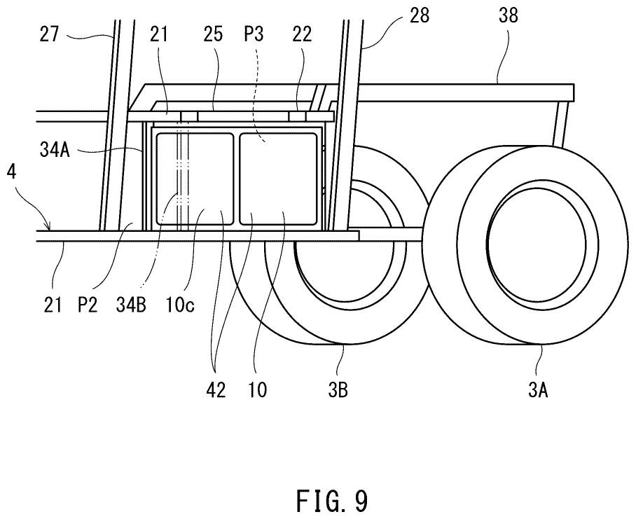

FIG. 9 is a perspective view showing the frame body 4 and the battery assembly 10 shown in FIG. 2 when viewed from the front left side through the rear entrance opening P2. In FIG. 9, the partition wall 50 is not shown. As shown in FIG. 9, when viewed in the direction facing the outer side surface 10c of the battery assembly 10, the outer vertical frame 34B of the rear seat support frame 25 overlaps the battery assembly 10. When the outer vertical frame 34B is detached, the rear seat support frame 25 opens the under-seat space S1 in the horizontal direction through the battery passing opening P3.

As shown in FIGS. 8 and 9, when viewed in the direction D facing the outer side surface 10c of the battery assembly 10, the battery passing opening P3 of the rear seat support frame 25, the partition opening 61a of the partition wall 50, and the rear entrance opening P2 between the front post 27 and the rear post 28 overlap each other. When viewed in the direction D facing the outer side surface 10c of the battery assembly 10, each battery 42 is located inside the battery passing opening P3, the partition opening 61a, and the rear entrance opening P2.

In the present embodiment, when viewed in the direction D facing the outer side surface 10c of the battery assembly 10, the entire outer side surface 10c of the battery assembly 10 is located inside the battery passing opening P3, the partition opening 61a, and the rear entrance opening P2. Regarding the battery assembly 10, a virtual projection region V3 defined by extending the outer side surface 10c in the direction D perpendicular to the outer side surface 10c is located inside the battery passing opening P3, the partition opening 61a, and the rear entrance opening P2. Therefore, regarding the battery 42, a virtual projection region defined by extending the front surface 42a of the battery 42 in the direction D perpendicular to the front surface 42a of the battery 42 is located inside the battery passing opening P3, the partition When the outer vertical frame 34B of the rear seat support frame 25 and the lid 62 of the partition wall 50 are detached, each battery 42 can pass through the battery passing opening P3, the partition opening 61a, and the rear entrance opening P2. In the present embodiment, when the outer vertical frame 34B of the rear seat support frame 25 and the lid 62 of the partition wall 50 are detached, the battery assembly 10 can pass through the battery passing opening P3, the partition opening 61a, and the rear entrance opening P2.

According to the off-road vehicle 1 described above, in the vehicle plan view, the outer side surface 10c and inner side surface 10d of the battery assembly 10 are inclined with respect to the vehicle center line Y extending in the vehicle front-rear direction. Therefore, the degree of freedom of the arrangement of the battery assembly 10 having the substantially hexahedron shape increases. Thus, even when the battery assembly 10 is large, such battery assembly 10 can be suitably located in the under-seat space S1.

Since the battery assembly 10 is located so as to be directed to the rear entrance opening P2, the battery assembly 10 or the battery 42 can be moved to the inside or outside of the vehicle by utilizing the rear entrance opening P2.

Since the virtual projection region V3 defined by extending the outer side surface 10c of the battery assembly 10 in the direction D is located inside the rear entrance opening P2, the battery assembly 10 or the battery 42 can be moved to the inside or outside of the vehicle by utilizing the rear entrance opening P2.

When viewed in the direction facing the outer side surface 10c, the outer side surface 10c of the battery assembly 10 is located between the front post 27 and the rear post 28. Therefore, even when the battery assembly 10 is located obliquely with respect to the vehicle center line Y, a worker can easily access the outer side surface 10c of the battery assembly 10 through a space between the front post 27 and the rear post 28. For example, the worker can easily take out the entire battery assembly 10 or part of the battery assembly 10 to the outside of the vehicle. Therefore, the ease of maintenance of the battery assembly 10 can be improved.

The outer vertical frame 34B is the reinforcing frame, i.e., the detachable frame which is detachably fixed to the floor frame 21. Therefore, while increasing the strength of the frame body 4 by the outer vertical frame 34B, the worker can detach the outer vertical frame 34B to easily access the outer side surface 10c of the battery assembly 10 through the space between the front post 27 and the rear post 28.

Since the space between the front post 27 and the rear post 28 corresponds to the space between the front seat 5 and the rear seat 6, the space between the front post 27 and the rear post 28 can be widely open toward the vehicle lateral side, and this can improve the ease of maintenance of the battery assembly 10.

In the battery assembly 10, the virtual extension surface V1 of the front surface 10a extending obliquely with respect to the vehicle left-right direction and the virtual extension surface V2 of the rear surface 10b extending obliquely with respect to the vehicle left-right direction pass through the space between the front post 27 and the rear post 28. Therefore, even when the battery assembly 10 is located obliquely with respect to the vehicle center line Y, the worker can easily access the outer side surface 10c of the battery assembly 10 through the space between the front post 27 and the rear post 28. For example, the worker can easily take out the entire battery assembly 10 or part of the battery assembly 10 to the outside of the vehicle. Therefore, the ease of maintenance of the battery assembly 10 can be improved.

In the battery assembly 10, the front surface 10a extends obliquely with respect to the vehicle left-right direction, and the outer side surface 10c is located so as to be directed to the vehicle left-right direction and the vehicle front side. Therefore, the degree of freedom of the arrangement of the battery assembly 10 increases. Moreover, even when the battery assembly 10 is large, such battery assembly 10 can be suitably located in the under-seat space S1.

The front corner portion 10e of the battery assembly 10 is located at the vehicle front side of the rear seat support frame 25. Therefore, the battery assembly 10 can be increased in size while being located in the under-seat space S1.

Regarding positions in the vehicle left-right direction, the position of the front corner portion 10e of the battery assembly 10 is substantially the same as the position of the middle portion 6d of the seating region 6c of the rear seat 6. Therefore, when viewed in the vehicle front-rear direction, the front corner portion 10e of the battery assembly 10 is located between the legs of the occupant seated on the rear seat 6. Thus, even when the front corner portion 10e of the battery assembly 10 is located at the vehicle front side of the rear seat support frame 25, the front corner portion 10e of the battery assembly 10 can be prevented from becoming a hindrance to the legs of the occupant.

Since the partition wall 50 includes the projecting portion 50d that projects toward the rear foot space S2 located in front of the partition wall 50 and covers the front corner portion 10e of the battery assembly 10 from the vehicle front side, the layout efficiency can be improved. Moreover, since the portion of the partition wall 50 which is adjacent to the projecting portion 50d is located at the vehicle rear side of a tip of the projecting portion 50d, the rear foot space S2 located in front of the partition wall 50 can be made as large as possible.

The vertical frame 35 is located so as to be directly or indirectly opposed to the rear surface 10b of the battery assembly 10 in the vehicle front-rear direction. Therefore, the large battery assembly 10 can be suitably located in the under-seat space S1, and the battery assembly 10 can be protected by the rear post 28 from behind.

The front corner portion 10e of the battery assembly 10 is located at the vehicle front side of the vertical frame 34. Therefore, even when the battery assembly 10 is large, such battery assembly 10 can be suitably located in the under-seat space S1. Moreover, the battery assembly 10 can be protected by the vertical frame 34 from front.

The front corner portion 10e of the battery assembly 10 projects toward the vehicle front side from the space between the inner vertical frame 34A and the outer vertical frame 34B. Therefore, the large battery assembly 10 can be suitably located in the under-seat space S1, and the battery assembly 10 can be protected by the inner vertical frame 34A and the outer vertical frame 34B from both sides in the vehicle left-right direction.

The rear corner portion 10f of the battery assembly 10 is located at the vehicle rear side of the rear seat support frame 25. Therefore, the battery assembly 10 can be increased in size while being located in the under-seat space S1.

The battery assembly 10 is opposed to the rear fender 70 from the vehicle front side and the inside in the vehicle left-right direction. Therefore, the battery assembly 10 is located along the rear fender 70, and this can improve the layout efficiency.

In the vehicle plan view, the rear surface 10b of the battery assembly 10 extends along the lower rear frame 37 while being located inside the lower rear frame 37 in the vehicle left-right direction. Therefore, a space located inside the lower rear frame 37 in the vehicle left-right direction in the vehicle plan view can be effectively utilized.

The rear corner portion 10f of the battery assembly 10 is directed to the under-seat space S2 located vertically under the cargo bed 11. Therefore, even when the battery assembly 10 protrudes from the rear seat support frame 25 to the vehicle rear side, a space for the occupant can be prevented from being reduced in size.

In the vehicle plan view, the projecting amount L1 of the front corner portion 10e of the battery assembly 10 from the rear seat support frame 25 toward the vehicle front side is smaller than the projecting amount L2 of the rear corner portion 10f of the battery assembly 10 from the rear seat support frame 25 toward the vehicle rear side. Therefore, even when the battery assembly 10 protrudes from the under-seat space S1, the rear foot space S2 located in front of the rear seat support frame 25 can be prevented from being reduced in size.

The rear seat support frame 25 defines the battery passing opening P3 that opens the under-seat space S1 in the horizontal direction and has such a size that the battery 42 or the battery assembly 10 can pass therethrough. Therefore, the battery 42 or the battery assembly 10 can be mounted on the vehicle 1 by being carried from the rear entrance opening P2 through the battery passing opening P3 to the under-seat space S1. Thus, when carrying the battery 42 or the battery assembly 10, it is unnecessary to lift the battery 42 or the battery assembly 10 up high. Therefore, the battery 42 or the battery assembly 10 can be easily mounted on the vehicle 1.

Since the partition opening 61a of the partition wall main body 61 is closed by the lid 62, foreign matters, such as rain water or sand, can be prevented from reaching the battery assembly 10 through the partition opening 61a of the partition wall 50. When replacing the battery 42, the partition opening 61a is opened by moving the lid 62. Thus, the battery 42 can be replaced without detaching the entire partition wall 50.

Since the outer vertical frame 34B is detachably fixed to the floor frame 21 and part of the rear seat support frame 25 by the fasteners B and crosses the battery passing opening P3, the rigidity of the rear seat support frame 25 can be increased. When replacing the battery 42, the outer vertical frame 34B is detached by removing the fasteners B. Thus, the battery 42 is prevented from interfering with the outer vertical frame 34B, and the battery 42 can be easily replaced.

The battery case 41 includes the guide 41b that guides the battery 42 between the battery passing opening P3 and the position of the battery 42 completely accommodated in the battery case 41. Therefore, the battery 42 can be guided by the guide 41b, and the battery 42 can be easily attached and detached.

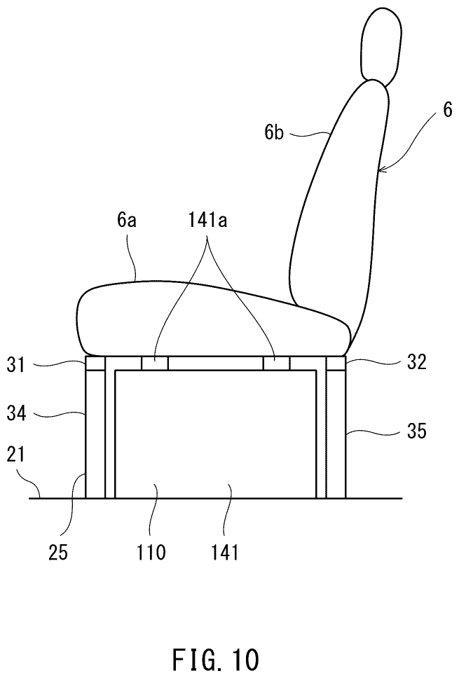

FIG. 10 is a left side view showing a battery assembly 110 of Modified Example and its vicinity. As shown in FIG. 10, a battery case 141 of the battery assembly 110 supports the rear seat 6. The battery case 141 is located at the floor frame 21. The battery case 141 includes a seat supporting portion 141a projecting upward toward the rear seat 6. An upper end of the seat supporting portion 141a supports a lower surface of the seat portion 6a of the rear seat 6 from below. Thus, the rigidity of the structure that supports the rear seat 6 can be increased.

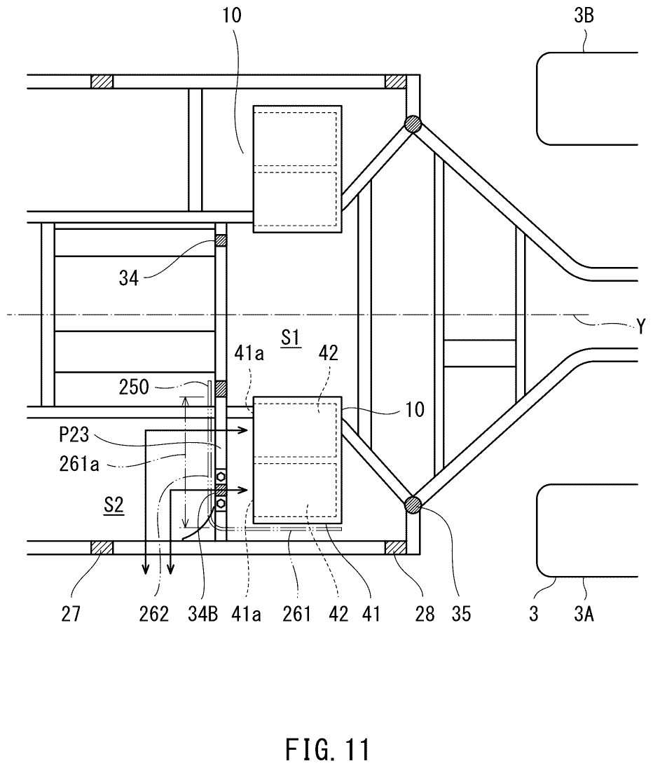

FIG. 11 is a diagram showing a battery layout of Modified Example and corresponding to FIG. 5. The same reference signs are used for the same components as Embodiment 1, and the repetition of the same explanation is avoided. As shown in FIG. 11, in the vehicle plan view, the battery assembly 10 is not inclined with respect to the vehicle center line Y. To be specific, the front surface 10a and rear surface 10b of the battery assembly 10 extend parallel to the vehicle left-right direction, and the outer side surface 10c and inner side surface 10d of the battery assembly 10 extend parallel to the vehicle center line Y. The battery assembly 10 is basically the same in structure as the battery assembly 10 of the above embodiment but is smaller than the battery assembly 10 of the above embodiment.

The rear seat support frame 25 defines a battery passing opening P23 that opens the under-seat space S1 to the vehicle front side when the outer vertical frame 34B is detached. A partition wall 250 that covers the under-seat space S1 from the vehicle front side and the outside in the vehicle left-right direction includes a partition wall main body 261 and a lid 262. The partition wall main body 261 includes a partition opening 261a that opens the under-seat space S1 and the battery passing opening P23 toward the vehicle front side.

When the outer vertical frame 34B and the lid 262 are detached, the under-seat space S1 communicates with the rear foot space S2 in the horizontal direction. Each of the partition opening 261a and the battery passing opening P23 has such a size that at least the battery 42 can pass therethrough. In the present embodiment, each of the partition opening 261a and the battery passing opening P23 has such a size that the battery assembly 10 can pass therethrough.

When taking out the battery 42 accommodated in the battery case 41, the battery 42 is pulled out to the rear foot space S2 through the battery passing opening P23 and the partition opening 261a and is then taken out to the outside of the vehicle through the battery passing opening P3. When attaching the battery 42, the battery 42 enters into the rear foot space S2 through the battery passing opening P23 from the outside of the vehicle and is then inserted into the accommodating space of the battery case 41 through the partition opening 261a and the battery passing opening P23.

According to the above configuration, the battery 42 or the battery assembly 10 can be mounted on the vehicle 1 by being carried from the rear entrance opening P2 to the under-seat space S1 through the battery passing opening P23. Thus, when carrying the battery 42 or the battery assembly 10, it is unnecessary to lift the battery 42 or the battery assembly 10 up high. Therefore, the battery 42 or the battery assembly 10 can be easily mounted on the vehicle 1. Since the other components are the same as those in Embodiment 1, explanations thereof are omitted.

The technology of the present disclosure is not limited to the above embodiment. For example, the number of rows of the occupant seats of the off-road vehicle 1 does not have to be two and may be one. To be specific, the off-road vehicle 1 may include only a driver's seat and a front passenger seat as the occupant seats. In this case, the battery assembly 10 may be located in the under-seat space corresponding to the driver's seat or the front passenger seat. The seat located vertically above the battery assembly 10 may be a bench seat extending in the vehicle left-right direction. The seat located vertically above the battery assembly 10 may include a front-rear slider that can adjust the position of the seat in the vehicle front-rear direction.

The battery assembly 10 does not have to project from the rear seat support frame 25 toward both of the vehicle front side and the vehicle rear side. The battery assembly 10 may project from the rear seat support frame 25 to only one of the vehicle front side and the vehicle rear side. The battery assembly 10 may be completely accommodated in the under-seat space S1 surrounded by the rear seat support frame 25.

Each of the front post 27 and the rear post 28 does not have to be part of the cabin frame 26. For example, the front post 27 may be part of the front seat support frame 24, and the rear post 28 may be part of the rear seat support frame 25. The battery assembly 10 may have a cube shape. The battery assembly 10 itself may be a battery. The off-road vehicle 1 may be a hybrid vehicle including both of an electric motor and an internal combustion engine as prime movers.

The foregoing has described the embodiment as an example of the technology disclosed in the present application. However, the technology in the present disclosure is not limited to this and is applicable to embodiments in which modifications, replacements, additions, omissions, and the like have been suitably made. Moreover, a new embodiment may be prepared by combining the components described in the above embodiment. For example, some of components or methods in one embodiment may be applied to another embodiment. Some components in an embodiment may be separated from the other components in the embodiment and arbitrarily extracted. Furthermore, the components shown in the attached drawings and the detailed explanations include not only components essential to solve the problems but also components for exemplifying the above technology and not essential to solve the problems.

What is claimed is:

1. A vehicle comprising:
a left wheel and a right wheel which are located with an interval in a vehicle left-right direction;
a frame body including a floor frame and a seat support frame located at an upper side of the floor frame;
a seat supported by the seat support frame from below; and
a battery supported by the frame body, at least part of the battery being located in an under-seat space surrounded by the seat support frame and the floor frame, wherein:
the frame body defines an entrance opening which is located at a lateral side of the seat and through which an occupant passes when the occupant gets in and out of the vehicle; and
the seat support frame defines a battery passing opening which opens the under-seat space in a horizontal direction and has such a size that the battery passes through the battery passing opening.

2. The vehicle according to claim 1, further comprising a partition wall covering the under-seat space, wherein
the partition wall includes
a partition opening which makes the battery passing opening communicate with the entrance opening and has such a size that the battery passes through the partition opening and
a lid that openably closes the partition opening.

3. The vehicle according to claim 1, wherein:
the seat support frame further includes a reinforcing frame located so as to close part of the battery passing opening; and
the reinforcing frame is detachably fixed to part of the seat support frame by a fastener.

4. The vehicle according to claim 1, further comprising a guide that guides the battery between the battery passing opening and a predetermined position in the under-seat space.

5. The vehicle according to claim 1, wherein:
the battery includes an outer surface that is directed to an outside in the vehicle left-right direction, and in a vehicle plan view, inclined with respect to a vehicle center line extending in a vehicle front-rear direction; and
the battery is located such that a virtual extension region defined by extending the outer surface in a direction perpendicular to the outer surface is located inside the entrance opening.

6. The vehicle according to claim 1, further comprising a battery case accommodating the battery, wherein
the battery case includes a seat supporting portion that supports the seat.

7. The vehicle according to claim 1, wherein the battery is directed to the entrance opening.

8. The vehicle according to claim 1, wherein:
the frame body further includes
a rear post that is located behind the under-seat space and at a vehicle left-right direction outside portion of the floor frame and extends upward from the floor frame and
a front post that is located at the vehicle left-right direction outside portion of the floor frame and in front of a foot space located in front of the seat support frame and extends upward from the floor frame; and
an outer surface of the battery which is directed to an outside in the vehicle left-right direction and a vehicle front side is located between the front post and the rear post when viewed in a direction facing the outer surface.

9. The vehicle according to claim 8, wherein:
the frame body includes a reinforcing frame that overlaps the outer surface of the battery when viewed in the direction facing the outer surface of the battery; and
the reinforcing frame is detachably fixed to the floor frame.

10. The vehicle according to claim 8, wherein:
the seat includes a rear seat; and
the seat support frame includes a rear seat support frame that supports the rear seat from below,
the vehicle further comprising a front seat located in front of the rear seat, wherein:
the frame body further includes a front seat support frame that supports the front seat from below; and
the foot space includes a rear foot space located between the front seat support frame and the rear seat support frame.

11. The vehicle according to claim 1, wherein:
the frame body further includes
a rear post that is located behind the under-seat space and at a vehicle left-right direction outside portion of the floor frame and extends upward from the floor frame and
a front post that is located at the vehicle left-right direction outside portion of the floor frame and in front of a foot space located in front of the seat support frame and extends upward from the floor frame; and
a virtual extension surface of a front surface of the battery and a virtual extension surface of a rear surface of the battery pass through a space between the front post and the rear post, the front surface and the rear surface extending obliquely with respect to the vehicle left-right direction.
